(19) United States
(12) Patent Application Publication
(10) Pub. No.: US 2025/0360751 A1
(43) Pub. Date: Nov. 27, 2025

(54) INFLATABLE ARCH SYSTEMS AND METHODS OF USE

(71) Applicant: INFLATABLE BALLOON ARCHES LLC, Tulsa, OK (US)

(72) Inventor: Peyton Clarke, Tulsa, OK (US)

(21) Appl. No.: 19/217,926

(22) Filed: May 23, 2025

Related U.S. Application Data
(60) Provisional application No. 63/651,334, filed on May 23, 2024.

(51) Int. Cl. B44F 99/00; A63H 27/10

(52) U.S. Cl. CPC B44F 99/00; A63H 27/10; A63H 2027/1041; A63H 2027/1083

(57) ABSTRACT

A modular inflatable structure facilitates versatile three-dimensional configurations through a frame supporting multiple inflatable components. The structure comprises a frame constructed from malleable plastic members that provides structural integrity while maintaining flexibility. The frame incorporates a plurality of multi-way-valves affixed at junction points, which receive and secure inflatable attachments while regulating airflow. Attached to these valves are numerous inflatable balls creating visual interest and dimensional variation. An inflation valve assembly receives at least one longitudinal member and regulates airflow into and out of the inflatable attachments. Internal hollow channels within the longitudinal members provide continuous airflow pathways throughout the structure. The modular inflatable structure may include detachable accessories with pre-inflated balls connected via stems that couple to the frame using clips. This design facilitates rapid assembly and reconfiguration for temporary installations across various applications, with the frame forming a backbone to support modular arch structures while maintaining pressure stability through one-way valve mechanisms.

### CROSS REFERENCE TO RELATED APPLICATIONS

This application claims the benefit and priority of U.S. Provisional Application Ser. No. 63/651,334, filed on May 23, 2024, which is hereby incorporated herein by reference, including all references and appendices cited therein, for all purposes, as if fully set forth herein.

### SUMMARY

In one aspect, the present disclosure relates to a modular inflatable structure. The modular inflatable structure includes a plurality of unibody inflatable modules, each formed by welded seams to define an enclosed inflatable body. The structure includes hook-and-loop connectors affixed to exterior surfaces of the inflatable modules, with the connectors having molded male and female components positioned on the inflatable modules. Tubes are joined to respective inflatable modules by circumferential lap seams, and accessory members are joined to the tubes by circumferential lap seams.

In certain implementations, one of the unibody inflatable modules is weighted to remain in contact with a subordinate surface. The inflatable modules may include a single valve to permit inflation of the entire modular structure from one point. In some embodiments, the accessory members include inflatable balls, and at least one inflatable ball may include a one-way valve to retain internal pressure after inflation. The tubes may be configured to permit angular orientation of adjacent modules. In some implementations, the inflatable modules are arranged to define an arch, and the hook-and-loop connectors may be positioned on opposed ends of each accessory member to facilitate end-to-end coupling.

According to another aspect, a modular support frame assembly includes a frame with a plurality of longitudinal members joined to define a three-dimensional shape. The assembly includes 4-way-valves affixed to the frame and configured to receive external modular elements. Inflatable attachments are coupled to the 4-way-valves, and an inflation valve assembly is configured to receive at least one of the longitudinal members and regulate airflow into and out of the inflatable attachments. In some implementations, the inflatable attachments are spherical in shape and in fluid connection with the frame using one-way valves.

In certain implementations, the longitudinal members each include a bendable air tube, and the 4-way-valves are configured to interlock with a portion of the inflatable attachments using mechanical fit. The assembly may include a detachable accessory with a pre-inflated ball and stem, with the stem coupleable to one of the longitudinal members via a clip. The frame may form a backbone to support a modular arch structure. In some embodiments, the inflatable attachments are disposed at uniform intervals along a curved portion of the frame, and the frame may include articulating joints to enable angular adjustments.

In yet another aspect, a modular inflatable structure includes a frame with longitudinal members joined to define an arcuate shape. The longitudinal members are constructed from malleable plastic material that permits controlled deformation while maintaining structural integrity, and feature internal hollow channels that provide continuous airflow pathways through the frame. The structure includes four-way valves positioned at junction points on the frame, with the four-way valves having quick connect junctions to control air flow for inflation and deflation. An inflation valve separate from the four-way valves introduces air into the structure. The structure also includes inflatable attachments, each with an inflatable ball connected to a stem. The stem incorporates a one-way valve mechanism positioned near a junction with the inflatable ball and is configured for attachment to at least one of the four-way valves on the frame. A connector interface allows coupling with another modular inflatable structure or terminating the modular inflatable structure.

### BRIEF DESCRIPTION OF THE DRAWINGS

FIG. 1 illustrates a perspective view of a modular inflatable structure according to a first embodiment, showing a plurality of unibody inflatable modules arranged to define an arch.

FIG. 2 illustrates a detailed view of the unibody inflatable modules of the first embodiment, showing welded seams and a sectional view 2-2 depicting an internal metal frame.

FIG. 3 illustrates a detailed view of connection mechanisms of the first embodiment, showing male hook connectors and female loop connectors molded from plastic and welded to the unibody inflatable modules.

FIG. 4 illustrates a detailed view of circumferential lap seams of the first embodiment, showing the joining of accessory balls to tubes and tubes to a module body.

FIG. 5 illustrates a perspective view of a modular support frame assembly according to a second embodiment, showing a frame comprising longitudinal members with inflatable attachments coupled thereto.

FIG. 6 illustrates a detailed view of the second embodiment, showing a connector interface and inflatable attachments coupled to the frame via stems and a four-way valve.

FIG. 7 illustrates a detailed view of a longitudinal member of the second embodiment, showing connection details of the inflatable attachments to the frame.

FIG. 8 illustrates a detailed view of a detachable accessory component of the second embodiment, showing an inflatable ball connected to a stem configured for attachment to a longitudinal member of the frame.

### DETAILED DESCRIPTION OF EXAMPLE EMBODIMENTS

### Overview

The present disclosure pertains to modular inflatable and semi-structural systems engineered for deployment in environments that require portable, reconfigurable, and structurally coherent installations. The disclosure includes two distinct but complementary approaches: a modular inflatable assembly composed of unibody pressurizable modules, and a support frame system configured to accept inflatable attachments and provide structural reinforcement. Each system is independently operable and addresses overlapping use scenarios through different mechanical architectures and connection strategies.

The modular inflatable assembly includes a plurality of sealed inflatable modules formed from high-performance thermoplastic materials. These modules are fabricated as unibody volumes using precision welding techniques to ensure airtightness and mechanical cohesion. Each module incorporates a set of molded interconnection features affixed to its exterior, including hook-and-loop style connectors formed from thermoplastic material. These connectors enable secure, repeatable coupling between adjacent modules.

Tubular junctions extend from selected module surfaces and are affixed using circumferential lap seams. Accessory components, such as inflatable spherical elements, are joined to these tubes using similar seam techniques, enabling complex spatial configurations. In some implementations, modules include internal bendable air channels to preserve geometry once inflated. Other configurations employ internal support structures to enable angular adjustments and controlled articulation without compromising system integrity.

In another embodiment, a structural framework system is disclosed, including an arrangement of rigid or semi-rigid members configured to form a backbone for mounting inflatable components. This framework includes mechanical interface points for receiving external modules or inserts, such as connector plugs or receptacles. Inflatable elements, which may take the form of spheres or other decorative volumes, are coupled to the frame through mechanical fittings or integrated valve systems.

A centralized valve assembly may be used to coordinate the inflation and deflation of attached elements. The frame may also incorporate bendable or articulated sections that allow changes in shape or orientation. This infrastructure supports stable deployment of inflatable features while allowing shape retention, controlled pressurization, and simplified mechanical integration with additional components or mounting platforms.

These systems provide solutions for the rapid deployment of structural or decorative assemblies across a variety of use contexts. Each system enables modularity, geometric adaptability, and reliable component coupling, while preserving independence in design philosophy and engineering execution.

### Example Implementations

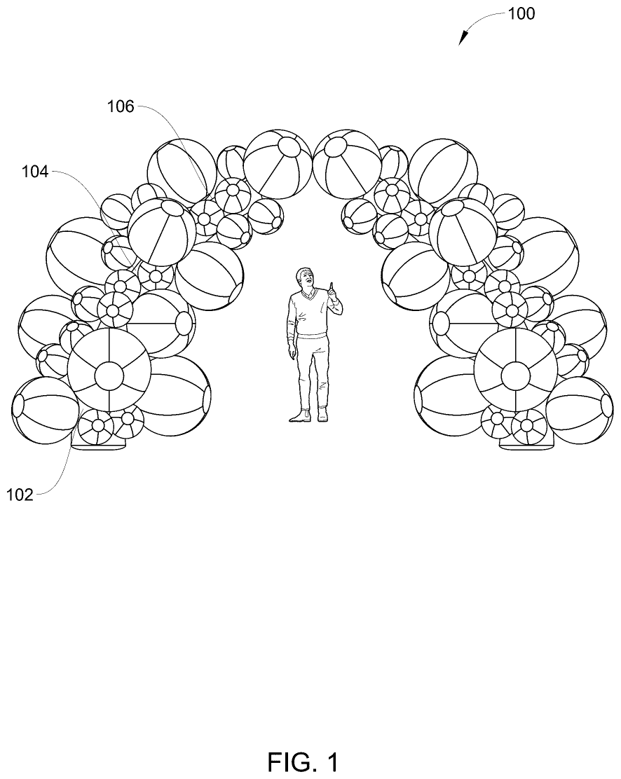

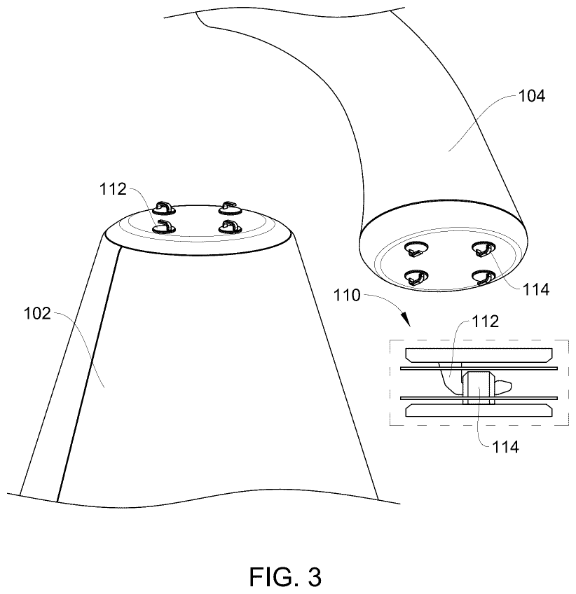

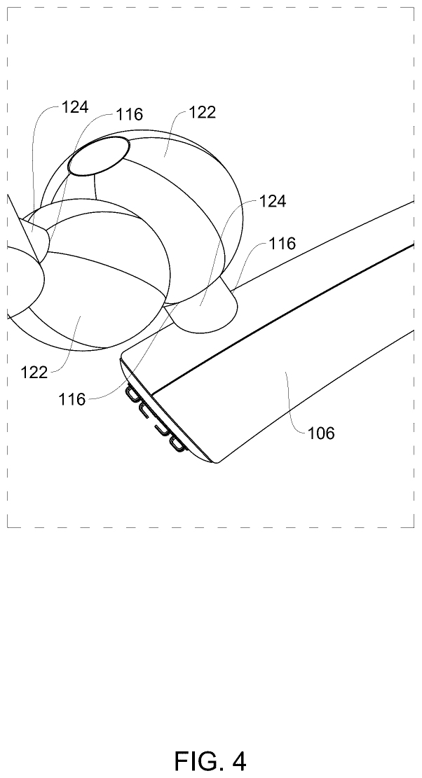

Referring to FIGS. 1-4, a modular inflatable structure 100 comprises a plurality of unibody inflatable modules 102, 104, and 106. These unibody inflatable modules 102, 104, and 106 include bases and arched sections. Each unibody inflatable module 102, 104, 106 is constructed with a material selected from high-quality PVC and TPU, and features welded seams 108 to ensure airtightness and structural integrity.

In this first embodiment, the modular inflatable structure 100 includes a connection mechanism 110 for securely interconnecting the plurality of unibody inflatable modules 102, 104, 106. This connection mechanism 110 includes male hook connectors 112 and female loop connectors 114 molded from plastic and welded to the unibody inflatable modules 102, 104, 106.

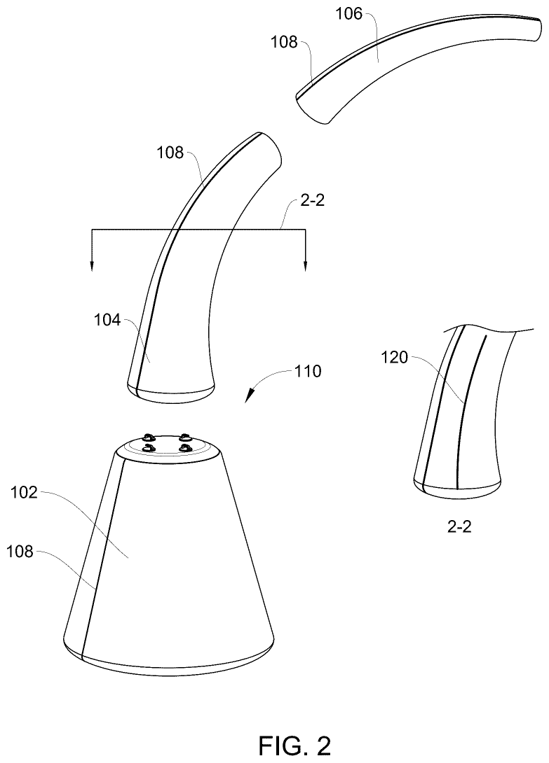

Each unibody inflatable module 102, 104, 106 in this first embodiment includes a fully filled bendable air tube 118 to maintain the unibody inflatable module's shape and flexibility. In some embodiments, one or more of the unibody inflatable modules, such as unibody inflatable module 104 includes an inner metal frame 120 (see FIG. 2) providing structural support and allowing for bending and rotation to achieve a desired shape. Some embodiments do not include an inner metal frame 120 but depend on the structural rigidity of the plastic used.

In some embodiments, the modular inflatable structure 100 employs circumferential lap seams 116 for joining accessory balls to tubes and tubes to the module body, thereby enhancing the strength and durability of the connections. In more detail, accessory balls 122 are welded to tubes 124 and connected to one of the unibody inflatable modules 102, 104, 106. For clarity of illustration in FIG. 1, some accessory balls 122 are not shown welded to the unibody inflatable modules 102, 104, 106. In some embodiments, the base unibody inflatable module 102 has a single one-way valve 126. Once the whole modular inflatable structure 100 is inflated, the single one-way valve 126 is opened letting all air escape. Thus, the components comprise a single system with a single inflate point just like a beach ball. The tubes 124 are welded to the module body, serving to connect various unibody inflatable modules 102, 104, 106 and accessory balls 122.

In certain embodiments, the modular inflatable structure may utilize silicone-reinforced TPU for the construction of the unibody inflatable modules. This material configuration may provide enhanced tear resistance while maintaining the flexibility characteristics desirable for assembly and disassembly operations. In some implementations, the TPU material may include self-healing polymer components that respond to punctures by initiating a localized chemical reaction that seals minor breaches in the surface integrity. Certain embodiments may feature unibody inflatable modules constructed from optically clear TPU, allowing visual access to the internal structures and enabling light transmission through the modules. In yet other embodiments, the TPU or PVC material may incorporate antimicrobial additives dispersed throughout the polymer matrix.

According to one embodiment, the connection mechanism for interconnecting the plurality of modules may comprise magnetic quick-connect elements in place of or in addition to hook and loop connectors. These magnetic elements may be molded from ferromagnetic materials and welded to the modules in positions that facilitate alignment and connection when modules are brought into proximity. In another embodiment, the connection mechanism may include twist-lock connectors featuring circumferential engagement surfaces that create pressure seals when rotated into the locked position. In a further alternative embodiment, the modules may include interlocking geometric patterns formed directly in the module interfaces. These patterns may provide mechanical engagement without requiring separate connector components.

In some embodiments, the modular inflatable structure may incorporate illumination elements positioned within the internal structure of the modules or tubes. These illumination elements may include low-voltage LED components connected to power sources integrated within one or more of the unibody inflatable modules. In certain implementations, electronic pressure sensors may be positioned within the modules. These sensors communicate with external devices through wireless transmission protocols to provide inflation status information. Some embodiments may feature unibody inflatable modules with multiple internal chambers separated by flexible dividers, allowing different sections of the same module to maintain different pressure levels. In other embodiments, thin-film photovoltaic elements may be applied to exterior surfaces of the modules. These elements convert ambient light to electrical energy for powering integrated electronic components.

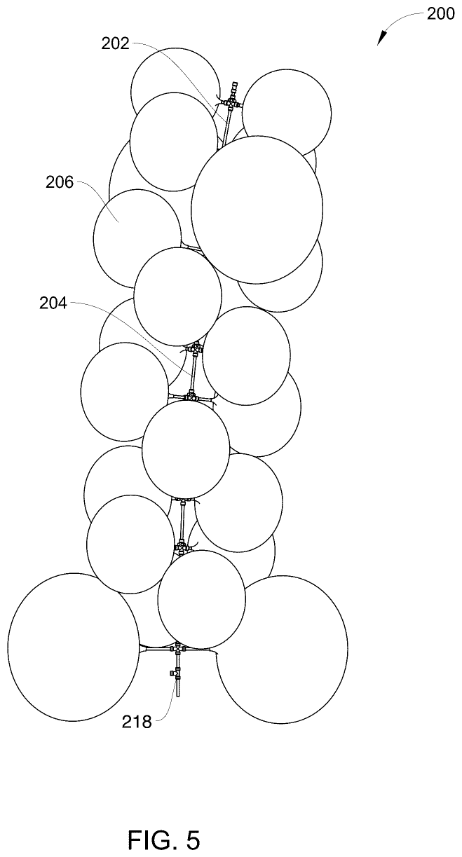

FIG. 5 illustrates a second embodiment comprising a modular support frame assembly 200. The modular support frame assembly 200 includes a frame 202 comprising a plurality of longitudinal members 204 joined to define a three-dimensional shape. The frame 202 is constructed from plastic members to provide essential support and flexibility.

The longitudinal members 204 are constructed from malleable plastic material that permits controlled deformation while maintaining structural integrity. These longitudinal members 204 can be bent and shaped into various configurations to achieve desired geometries for the frame 202. Each longitudinal member 204 features internal hollow channels that provide continuous airflow pathways through the frame 202 and into the connected accessory components. This integrated air distribution system enables unified inflation of the entire assembly through a single valve point, eliminating the need for multiple inflation ports. The deformable nature of the longitudinal members 204 allows the frame 202 to be reconfigured while maintaining the pneumatic connections between components. The material composition of the longitudinal members 204 provides sufficient rigidity to support the attached inflatable elements while remaining flexible enough for manual manipulation during setup and adjustment of the modular support frame assembly 200.

A plurality of inflatable attachments 206 are coupled to the frame 202. The inflatable attachments 206 are spherical in shape and are arranged to create a vertical structure with an organic, clustered appearance. The frame 202 forms a backbone to support a modular arch structure, maintaining the overall integrity and shape of the structure.

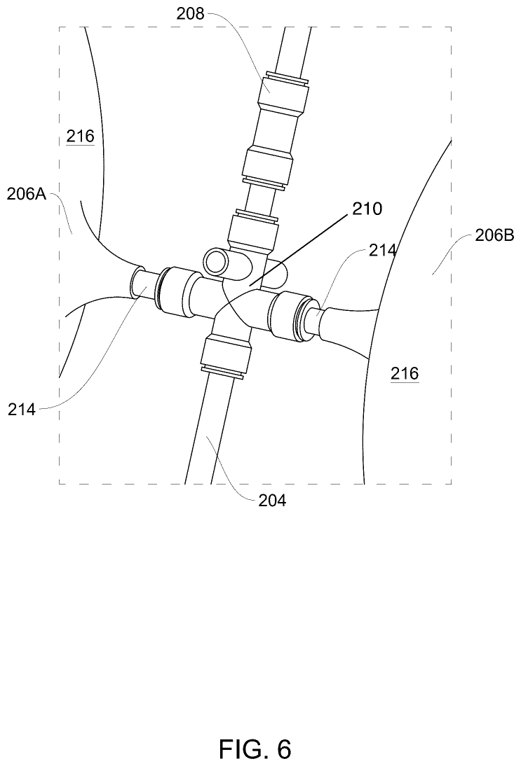

As shown in FIG. 6, the modular support frame assembly 200 includes a connector interface 208 affixed to the frame 202 and configured to receive adjacent longitudinal members or act as a stop that terminates the modular support frame assembly 200. For example, the connector interface 208 can couple two adjacent modular support frame assemblies, for example, a left and right assemblies.

The modular support frame assembly 200 also includes a plurality of four-way valves, such as four-way valve 210. The four-way valves 210 comprise quick connect junctions and are positioned on the frame 202 to control air flow for inflation and deflation of the modular support frame assembly 200. The four-way valves 210 are strategically positioned to allow for efficient air flow management, ensuring that the components can be quickly and effectively inflated or deflated as required. The four-way valves 210 are designed to maintain airtight seals, preventing any loss of air that could compromise the structural integrity of the inflatable components.

In FIG. 6, the 4-way valve 210 connects with the longitudinal member 204, the connector interface 208, and two inflatable attachments 206A and 206B. In other embodiments, the 4-way valve 210 can interconnect upper and lower longitudinal members, as well as adjacent lateral accessory components. The 4-way valve 210 is configured to interlock with accessory component using mechanical fit. In some instances, the 4-way valve 210 provide articulating joints configured to enable angular adjustments without losing stability.

In more detail, the inflatable attachments 206A and 206B each include a stem 214 that couples with the 4-way valve 210, as well as an inflatable ball 216. The stem 214 is configured as a hollow tube constructed from flexible material that maintains an airtight passage between the 4-way valve 210 and the inflatable ball 216. The stem 214 incorporates a one-way valve mechanism positioned near its junction with the inflatable ball 216, allowing air to flow into the inflatable ball 216 during inflation while preventing backflow when pressure in the frame 202 decreases during configuration adjustments or partial deflation of other components.

The stem 214 is designed with a tapered end that creates an interference fit when inserted into designated ports on the 4-way valve 210, ensuring a secure pneumatic connection without requiring additional fasteners. In certain implementations, the stem 214 may include circumferential ridges that engage with corresponding grooves in the valve ports to enhance the mechanical connection. The length of each stem 214 may vary among the inflatable attachments 206A and 206B to create visual variety in the final assembly, with some inflatable balls 216 positioned closer to the frame 202 while others extend further outward.

The stem 214 is configured for attachment to the frame 202, providing additional customization options for the modular structure. The one-way valve ensures that once the inflatable ball 216 is inflated, air remains trapped within the inflatable ball 216 even if pressure changes occur in other parts of the system. The inflatable attachments 206A and 206B are disposed at uniform intervals along a curved portion of the frame 202, enabling secure attachment while maintaining the inflated state of the inflatable ball 216. This arrangement allows for individual inflatable attachments 206A and 206B to be removed and replaced without deflating the entire assembly, enhancing the modularity and reconfigurability of the system.

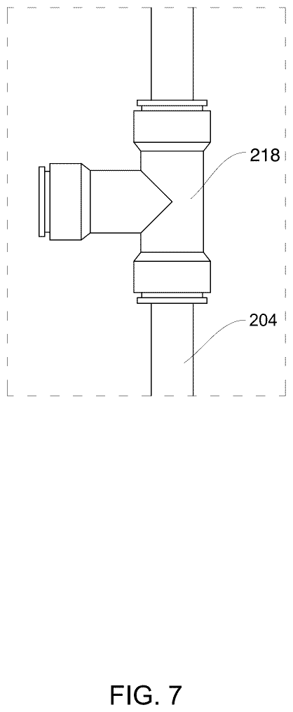

In FIG. 7, the modular support frame assembly includes an inflation valve 218 separate from the valve assembly. The inflation valve 218 is designed for ease of use, allowing for quick and straightforward inflation with minimal effort. The inflation valve 218 is equipped with mechanisms to prevent backflow, ensuring that once the air is introduced into the structure, it remains securely within.

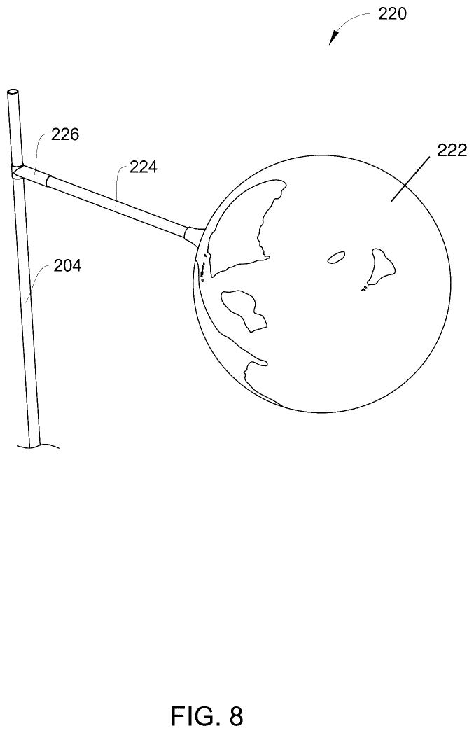

FIG. 8 illustrates a detachable accessory component 220 of the second embodiment. The accessory component 220 comprises an inflatable ball 222 connected to a stem 224 via a clip 226. The main stem 224 is configured for attachment to the longitudinal member 204, providing additional customization options for the modular structure. In this example, the inflatable ball 222 is permanently inflated and connectable to the frame via the longitudinal member 204.

According to further embodiments, the detachable accessory components or inflatable members may comprise shapes other than spherical balls, including but not limited to cubic, pyramidal, cylindrical, toroidal, or irregular organic forms. These alternative shape accessory members maintain the connection mechanism of circumferential lap seams for joining to tubes. In some implementations, the unibody inflatable modules may feature asymmetrical geometries designed to create specific architectural forms when assembled in predetermined configurations. Certain embodiments may include tubes with telescoping sections that can be extended or contracted to adjust the spacing between connected modules. In another embodiment, base modules may incorporate widened lower sections, stabilizing ballast compartments, or extended support structures to enhance stability when the modular inflatable structure is positioned on various surfaces.

In some embodiments, the modular inflatable structure may be configured with attachment points for securing weatherproof covering materials. These coverings transform the structure into enclosed shelters suitable for temporary habitation or storage. Certain implementations may feature unibody inflatable modules with specialized surface textures or contours designed to provide therapeutic support for rehabilitation applications. In other embodiments, the modules may be shaped and sized to function as furniture components when inflated and assembled in specific configurations. Some embodiments may include unibody inflatable modules sized and proportioned for educational applications. The modules may be color-coded to facilitate learning objectives. In yet other embodiments, the materials selected for module construction may feature enhanced buoyancy characteristics for aquatic applications, with sealed compartments ensuring flotation even if some chambers experience pressure loss.

According to certain manufacturing embodiments, the welded seams forming the unibody inflatable modules may include ultrasonic welding patterns that create predetermined fold lines, allowing the modules to collapse in controlled patterns for storage. In some implementations, the modules may be formed through dual material extrusion processes that create regions of differing flexibility within a single module. Certain embodiments may feature integrated valve systems. A master valve controls airflow to multiple chambers through internal channels, simplifying the inflation process. In other embodiments, the manufacturing process may employ standardized connection interfaces across different module types, enabling compatibility between modules produced using different techniques or materials.

### Method of Using a Modular Inflatable Device

In an example method of using the modular inflatable device, a user may first arrange a plurality of unibody inflatable modules on a surface in a predetermined configuration. The user may position a first unibody inflatable module, which may be weighted, on a surface to serve as a base module. The user may then attach a second unibody inflatable module to the first unibody inflatable module by aligning male hook connectors on one module with corresponding female loop connectors on the adjacent module and pressing the surfaces together to create a secure connection.

The user may continue this process, connecting additional unibody inflatable modules to form a desired structure such as an arch. The user may then connect accessory members to the modules by attaching tubes to designated connection points on the modules using the circumferential lap seams provided. The user may rotate and adjust the angular orientation of the modules relative to each other to achieve the desired spatial arrangement, utilizing the flexibility provided by the tubes connecting adjacent modules.

Once the modular structure is assembled, the user may inflate the entire structure through a single valve located on one of the unibody inflatable modules. As air enters the system, it flows through the interconnected modules and tubes, inflating the entire assembly. The user may continue inflation until the desired firmness is achieved, then seal the valve. The welded seams and circumferential lap seams maintain airtight connections throughout the structure. If necessary, the user may separately inflate any accessory members equipped with one-way valves to ensure they maintain their shape and internal pressure.

The completed structure may serve as a decorative installation, event entrance, or temporary architectural element. When the user wishes to disassemble the structure, they may open the valve to release air, detach the hook-and-loop connectors, and store the deflated modules for future use.

### Method of Using a Modular Support Frame Assembly

In an example method of using the modular support frame assembly, a user may first connect a plurality of longitudinal members to form a frame structure. The user may join the longitudinal members at junction points using 4-way valves, which serve as both structural connectors and airflow regulators. The malleable plastic construction of the longitudinal members allows the user to bend and shape the frame to achieve a desired configuration, such as an arch or custom geometric form.

The user may then connect inflatable attachments to the frame by inserting the stems of the inflatable attachments into the 4-way valves. The stems may include one-way valve mechanisms that allow air to flow into the inflatable attachments but prevent backflow. The user may position these inflatable attachments at regular intervals along the frame or in a customized arrangement as needed for the specific application.

For additional customization, the user may attach pre-inflated detachable accessories to the longitudinal members using clips. These accessories may provide different visual elements without requiring integration into the inflation system of the main structure.

Once the assembly is constructed, the user may inflate the structure using the inflation valve assembly. As air enters the system, it flows through the internal hollow channels in the longitudinal members and into the connected inflatable attachments. The 4-way valves direct the airflow throughout the structure, ensuring even inflation. The user may continue inflation until the desired rigidity is achieved, then seal the inflation valve.

If the user wishes to modify the shape after inflation, the articulating joints and malleable construction of the longitudinal members permit adjustments without complete disassembly. The user may bend, rotate, or reposition elements of the frame to fine-tune the final appearance of the structure. For larger installations, the user may employ the connector interface to join multiple modular support frame assemblies, creating extended or complex configurations. When disassembly is desired, the user may open the inflation valve to release air, detach the inflatable attachments, and collapse the frame for storage or reconfiguration.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

1. A modular inflatable device, comprising:
a plurality of unibody inflatable modules, each formed by welded seams to define an enclosed inflatable body;
a plurality of hook-and-loop connectors affixed to exterior surfaces of the plurality of unibody inflatable modules, the plurality of hook-and-loop connectors comprising molded male and female components positioned on the plurality of unibody inflatable modules;
a plurality of tubes joined to respective inflatable modules by circumferential lap seams; and
one or more accessory members, each of which are joined to one of the plurality of tubes by circumferential lap seams.

2. The device of claim 1, wherein one of the unibody inflatable modules is weighted to remain in contact with a subordinate surface.

3. The device of claim 1, wherein each inflatable module includes a single valve configured to permit inflation of the modular inflatable device from one point.

4. The device of claim 1, wherein the one or more accessory members comprise inflatable balls.

5. The device of claim 1, wherein at least one inflatable ball includes a one-way valve configured to retain internal pressure after inflation.

6. The device of claim 1, wherein the plurality of tubes are configured to permit angular orientation of adjacent modules.

7. The device of claim 1, wherein the inflatable modules are arranged to define an arch.

8. The device of claim 1, wherein the plurality of hook-and-loop connectors are positioned on opposed ends of each one or more accessory member to facilitate end-to-end coupling.

9. A modular support frame assembly, comprising:
a frame comprising a plurality of longitudinal members joined to define a three-dimensional shape;
a plurality of multi-way-valves affixed to the frame and configured to receive external modular elements;
a plurality of inflatable attachments coupled to the plurality of multi-way-valves; and
an inflation valve assembly configured to receive at least one of the longitudinal members and regulate airflow into and out of the plurality of inflatable attachments.

10. The assembly of claim 9, wherein each of the multi-way-valves includes a four-way valve.

11. The assembly of claim 10, wherein the plurality of inflatable attachments are spherical in shape and are in fluid connection with the frame using one-way valves within connected stems.

12. The assembly of claim 11, wherein the plurality of longitudinal members each include a bendable air tube.

13. The assembly of claim 12, wherein each of the plurality of 4-way-valves are configured to interlock with a portion of the plurality of inflatable attachments using mechanical fit.

14. The assembly of claim 9, further comprising a detachable accessory that includes a pre-inflated ball and stem, the stem being coupleable to one of the longitudinal members via a clip.

15. The assembly of claim 11, wherein the frame forms a backbone to support a modular arch structure.

16. The assembly of claim 11, wherein the inflatable attachments are disposed at uniform intervals along a curved portion of the frame.

17. The assembly of claim 11, wherein the frame comprises articulating joints configured to enable angular adjustments.

18. A modular inflatable structure comprising:
a frame comprising a plurality of longitudinal members joined to define an arcuate shape, wherein the longitudinal members are constructed from malleable plastic material that permits controlled deformation while maintaining structural integrity, and wherein the longitudinal members feature internal hollow channels that provide continuous airflow pathways through the frame;
a plurality of four-way valves positioned at junction points on the frame, the four-way valves comprising quick connect junctions configured to control air flow for inflation and deflation of the structure;
an inflation valve separate from the four-way valves, the inflation valve configured to introduce air into the structure;
a plurality of inflatable attachments, each inflatable attachment comprising an inflatable ball connected to a stem, wherein the stem incorporates a one-way valve mechanism positioned near a junction with the inflatable ball, wherein the stem is configured for attachment to at least one of the four-way valves on the frame; and
a connector interface for coupling with another modular inflatable structure or terminating the modular inflatable structure.
